(19) United States
(12) Patent Application Publication
(10) Pub. No.: US 2021/0064293 A1
(43) Pub. Date: Mar. 4, 2021

(54) APPARATUS AND METHOD FOR TRANSMITTING MAP INFORMATION IN A MEMORY SYSTEM

(71) Applicant: SK hynix Inc., Icheon-si (KR)

(72) Inventor: Young-Ick Cho, Seoul (KR)

(73) Assignee: SK hynix Inc.

(21) Appl. No.: 16/841,431

(22) Filed: Apr. 6, 2020

(30) Foreign Application Priority Data
Aug. 30, 2019 (KR) 10-2019-0106958

(51) Int. Cl. G06F 3/06; G06F 12/10

(52) U.S. Cl. CPC G06F 3/0659; G06F 3/0604; G06F 3/0653; G06F 12/10; G06F 3/0673

(57) ABSTRACT

A controller for controlling a memory device can include first circuitry configured to perform a read operation in response to a read request, wherein the read operation includes an address translation, which is performed optionally in response to an inputted physical address, for associating a logical address inputted along with the read request with a physical address, and second circuitry configured to determine a usage frequency regarding map data used for the address translation. The first circuitry and the second circuitry can work independently and separately of each other.

### CROSS-REFERENCE TO RELATED APPLICATIONS

This patent application claims to the benefit of Korean Patent Application No. 10-2019-0106958, filed on Aug. 30, 2019, the entire disclosure of which is incorporated herein by reference.

### TECHNICAL FIELD

The technology and implementations disclosed in this patent document relate to a memory system operating using map information.

### BACKGROUND

Recently, a paradigm for a computing environment has shifted to ubiquitous computing, which enables computer systems to be accessed anytime and everywhere. As a result, the use of portable electronic devices, such as mobile phones, digital cameras, notebook computers and the like, are rapidly increasing. Such portable electronic devices include a data storage device operating together with a memory device. The data storage device can be used as a main storage device or an auxiliary storage device of a portable electronic device.

A data storage device using a nonvolatile semiconductor memory device is advantageous in that it has excellent stability and durability because it has no mechanical driving part (e.g., a mechanical arm). Such data storage device also has high data access speed and low power consumption. Examples of data storage devices having such advantages include a USB (Universal Serial Bus) memory device, a memory card having various interfaces, a solid state drive (SSD) or others.

### SUMMARY

Various embodiments of the disclosed technology provide a data processing system including a memory system, a controller for controlling a memory device, and a method for operating a memory system. The implementations of the disclosed technology can improve the performance of the memory system using mapping information.

In one aspect, a controller for controlling a memory device is provided to comprise: first circuitry configured to perform a read operation in response to a read request, wherein the read operation includes an address translation, which is performed when an inputted physical address for the read operation is not valid, the address translation associating a logical address inputted along with the read request with a physical address by mapping the logical address to the associated physical address based on mapping information; and second circuitry coupled to the first circuitry and configured to determine a usage frequency of the mapping information that indicates a number of times used for the address translation, wherein the first circuitry and the second circuitry operate independently and separately from each other.

In another aspect, a method for operating a memory system is provided. The method comprises: performing an operation in response to a request from a host by performing an address translation when the request includes an invalid physical address associated with the request, the address translation mapping a logical address included in the request to a corresponding physical address based on mapping information; and determining a usage frequency of the mapping information that indicates a number of times used for the address translation, wherein the performing of the operation and the determining of the usage frequency are executed using different resources of the memory system from each other.

In another aspect, a data processing system is provided to comprise: a host configured to transmit an operation request with a logical address at which the operation is to be performed; and a memory system configured to receive the operation request from the host and perform a corresponding operation at a location within the memory system, the location identified by a physical address associated with the logical address, wherein the memory system includes: first circuitry configured to perform an address translation depending on whether the operation request is inputted along with a valid physical address and the address translation mapping the logical address to the associated physical address based on mapping information; and second circuitry coupled to the first circuitry and configured to determine a usage frequency of the mapping information used for the address translation, wherein the first circuitry and the second circuitry operate independently and separately from each other.

### BRIEF DESCRIPTION OF THE DRAWINGS

The description herein makes reference to the accompanying drawings wherein like reference numerals refer to like parts throughout the figures.

FIG. 1 illustrates an example a host and a memory system in a data processing system based on an embodiment of the disclosed technology.

FIG. 2 shows an example of a data processing system including a memory system based on an embodiment of the disclosed technology.

FIG. 3 illustrates an example of a memory system in accordance with an embodiment of the disclosed technology.

FIG. 4 shows examples of configurations of a host and a memory system in a data processing system based on an embodiment of the disclosed technology.

FIG. 5 illustrates a read operation performed in a host and a memory system in a data processing system based on an embodiment of the disclosed technology.

FIG. 6 illustrates an example of a transaction between a host and a memory system in a data processing system based on an embodiment of the disclosed technology.

FIG. 7 describes example operations of a host and a memory system based on an embodiment of the disclosed technology.

FIG. 8 illustrates an example operation for determining and transmitting map information based on an embodiment of the disclosed technology.

FIG. 9 illustrates an example of an apparatus for determining and transmitting map information in accordance with an embodiment of the disclosed technology.

FIG. 10 shows an example method for operating a memory system based on an embodiment of the disclosed technology.

FIG. 11 describes an example of a transaction between a host and a memory system in a data processing system based on an embodiment of the disclosed technology.

FIG. 12 illustrates an example operation of a host and a memory system based on an embodiment of the disclosed technology.

FIG. 13 shows an example operation of a host and a memory system based on an embodiment of the disclosed technology.

FIG. 14 illustrates an example operation of a host and a memory system based on an embodiment of the disclosed technology.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

### DETAILED DESCRIPTION

Various embodiments of the disclosed technology are described with reference to the accompanying drawings. Elements and features of the disclosed technology, however, may be configured or arranged differently to form other embodiments, which may be variations of any of the disclosed embodiments.

In this disclosure, the terms “comprise,” “comprising,” “include” and “including” are open-ended. As used in the appended claims, these terms specify the presence of the stated elements and do not preclude the presence or addition of one or more other elements. The terms in a claim does not foreclose the apparatus from including additional components (e.g., an interface unit, circuitry, etc.).

In this disclosure, various units, circuits, or other components may be described as being “configured to” perform a task or tasks. In such contexts, “configured to” is used to connote a structure by indicating that the units/circuits/components include a structure (e.g., circuitry) that performs those task or tasks during operation. As such, the unit/circuit/component can be said to be configured to perform the task even when the specified unit/circuit/component is not currently operational (e.g., is not turned on or without being powered by a power source). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

Various terms such as “first”, “second”, are used in conjunction with and they generally do not imply any type of ordering (e.g., spatial, temporal, logical, etc.) unless otherwise expressly specify an ordering. The terms “first” and “second” do not necessarily imply that the first value must be written before the second value. Further, although the terms “first”, “second”, “third”, and so on may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination, action or outcome but does not foreclose additional factors that may affect the relevant determination, action or outcome. That is, a determination may be solely based on those factors or based, at least in part, on those factors. Consider the phrase “determine A based on B.” While in this case, B is a factor that affects the determination of A, such a phrase does not foreclose the determination of A from also being based on an additional factor C. In other instances, A may be determined based solely on B.

The technologies described in this patent document can provide a data processing system and a method for operating the data processing system. The data processing system may include components and resources such as a memory system and a host and dynamically allocate data paths used for transferring data between the components based on usages of the components and the resources.

An implementation of the disclosed technology can provide a method and an apparatus for improving or enhancing operations or performance of the memory system. While the memory system in the data process system transmits map information to the host or a computing device, the host or the computing device can transmit a request (or a command) including a specific item recognized from the map information. Due to the specific item delivered along with the request transmitted from the host to the memory system, the memory system can reduce a time spent on address translation for an operation corresponding to the request.

An implementation of the disclosed technology can provide an apparatus included in a data processing system including a host or a computing device, which is configured to check map information used in the process of performing a request or a command transmitted from the host or the computing device, monitor a frequency of usage regarding the map information for determining whether to transmit the map information to the host or the computing device, and transmit determined map information to the host or the computing device during an idle state of the memory system.

An implementation of the disclosed technology can provide a memory system including first circuitry, which is configured to determine map information to be transmitted to a host or a computing device and transmit the map information to a host or a computing device, and second circuitry which is configured to receive a request from the host or the computing device and perform operations corresponding to the request. The first circuitry and the second circuitry can work independently of each other so that, when the second circuitry performs an operation corresponding to the request, the first circuitry may perform a background operation. Accordingly, an operation of the first circuitry does not interfere with the operation of the second circuitry. It is possible to provide a method and an apparatus which can avoid deteriorating a data input/output (I/O) operation performed through the second circuitry of the memory system, which may be caused due to the operation of the first circuitry.

an implementation of the disclosed technology can provide a controller for controlling a memory device can include first circuitry configured to perform a read operation in response to a read request, wherein the read operation includes an address translation, which is performed when an inputted physical address for the read operation is not valid, the address translation associating a logical address inputted along with the read request with a physical address by mapping the logical address to the associated physical address based on mapping information; and second circuitry coupled to the first circuitry and configured to determine a usage frequency of the mapping information that indicates a number of times used for the address translation. The first circuitry and the second circuitry can operate independently and separately from each other.

An implementation of the disclosed technology can provide a controller configured to transmit at least some of the mapping information to the host based on the usage frequency of the mapping information.

An implementation of the disclosed technology can provide a controller configured to check whether the at least some of the mapping information has been transmitted to the host and further check whether the transmitted mapping information has been updated in a case that the at least one of the mapping information has been transmitted to the host.

An implementation of the disclosed technology can provide a controller configured to send an inquiry to the host to transmit the mapping information and transmit the mapping information based on a response from the host.

An implementation of the disclosed technology can provide a controller configured to set an access account for each piece of map data, increase an access count whenever a piece of map data corresponding to the access count is used for the address translation, and determine a piece of map data associating with an access count greater than a threshold as the at least some of the map data. Each piece of the mapping information can have a count information corresponding to the usage frequency.

An implementation of the disclosed technology can provide a controller configured to initialize the count information of a certain mapping information after determining to transmit the certain mapping information to the host.

An implementation of the disclosed technology can provide a controller configured to check whether the request is received with the corresponding physical address, and determine a validity of the corresponding physical address in a case that the corresponding physical address is received from the host.

An implementation of the disclosed technology can provide a controller can be configured to perform the address translation when the request does not include the valid physical address and omit the address translation when the request includes the valid physical address.

An implementation of the disclosed technology can provide a method for operating a memory system can include performing an operation in response to a request from a host by performing an address translation when the request includes an invalid physical address associated with the request, the address translation mapping a logical address included in the request to a corresponding physical address based on mapping information; and determining a usage frequency of the mapping information that indicates a number of times used for the address translation. The performing of the operation and the determining of the usage frequency are executed using different resources of the memory system from each other.

By the way of example but not limitation, the method can further include transmitting at least some of the mapping information to the host based on the usage frequency of the mapping information.

In an implementation, the method can further include checking whether the at least some of the mapping information has been transmitted to the host; checking whether the transmitted mapping information has been updated in a case that the at least some of the mapping information has been transmitted to the host; and excluding nonupdated one of the transmitted map data from the at least some of the map data.

In an implementation, the method can further include sending an inquiry to the host to transmit the at least some of the mapping information; and transmitting the at least some of the mapping information based on a response from the host.

For example, the step for determining the usage frequency can include increasing count information of a piece of the mapping information whenever the piece of the mapping information is used for the address translation; and determining to transmit, to the host, the piece of the mapping information that is greater than a threshold.

In an implementation, the method can further include initializing the count information of the piece of the mapping information after the determining to transmit the piece of the mapping information.

In an implementation, the method can further include checking whether the request has been received with the corresponding physical address; and determining a validity of the corresponding physical address in a case that the corresponding physical address has been received from the host.

In an implementation, the method can further include performing the address translation when the request does not include the valid physical address and omitting the address translation when the request includes the valid physical address.

An implementation of the disclosed technology can provide a data processing system can include a host configured to transmit an operation request with a logical address at which the operation is to be performed; and a memory system configured to receive the operation request from the host and perform a corresponding operation at a location within the memory system, the location identified by a physical address associated with the logical address. The memory system can include first circuitry configured to perform an address translation depending on whether the operation request is inputted along with a valid physical address and the address translation mapping the logical address to the associated physical address based on mapping information; and second circuitry coupled to the first circuitry and configured to determine a usage frequency of the mapping information used for the address translation. The first circuitry and the second circuitry can operate independently and separately from each other.

In an implementation, the memory system can be configured to transmit at least some of the mapping information to the host based on the usage frequency.

In an implementation, in the data processing system, the memory system can be configured to check whether the at least some of the mapping information has been transmitted to the host, and further check whether the transmitted mapping information has been updated in a case that the at least some of the mapping information has been transmitted to the host.

In an implementation, in the data processing system, the memory system can be configured to check whether the operation request is received with the associated physical address, and determine a validity of the associated physical address in a case that the associated physical address has been received from the host.

Embodiments of the disclosed technology will now be described with reference to the accompanying drawings, wherein like numbers reference like elements.

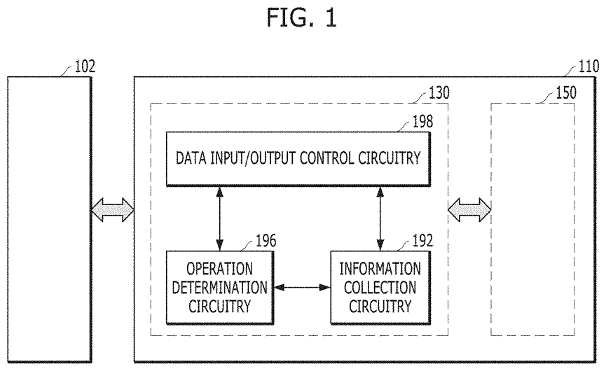

FIG. 1 shows an example of an apparatus for determining and transmitting map information in accordance with an embodiment of the disclosure.

Referring to FIG. 1, a host 102 and a memory system 110 may be communicatively coupled to each other. The host 102 may include a computing device and may be implemented in a form of a mobile device, a computer, a server, or others. The memory system 110 may receive a command from the host 102 and store or output data in response to the received command.

The memory system 110 may have a storage space including nonvolatile memory cells. For example, the memory system 110 may be implemented in a form of a flash memory, a solid-state drive (SSD), or others.

In order to store data requested by the host 102 in a storage space including the nonvolatile memory cells, the memory system 110 can perform a mapping operation for associating a file system used by the host 102 with a storage space including the nonvolatile memory cells. This can be referred as to an address translation between a logical address and a physical address. For example, an address identifying data in the file system used by the host 102 may be called a logical address or a logical block address, and the address indicating a physical location of data in the storage space including nonvolatile memory cells may be referred to as a physical address or a physical block address. When the host 102 sends a read command with a logical address to the memory system 110, the memory system 110 can search for a physical address corresponding to the logical address and then read and output data stored in the physical location indicated by the physical address. The mapping operation or the address translation may be performed during the search by the memory system 110 for the physical address corresponding to the logical address inputted from the host 102. The mapping operation or the address translation can be performed based on mapping information such as a mapping table which can associate a logical address with a physical address.

When a piece of data associated with a specific logical address is updated and programmed in a different location of the memory system 110, the map information associated with the specific logical address needs to be updated. When a certain update is made to map information, the updated map information is considered valid, while the previous map information before the update becomes invalid.

It is suggested to operate the host 102 to perform the mapping operation instead of the memory system 110. In this case, it is possible to reduce time taken by the memory system 110 to read and output data corresponding to a read command transmitted by the host 102. To perform the mapping operation, the host 102 may store and access at least some of map information and deliver, to the memory system 100, the read command with the physical address that is obtained through the mapping operation.

Referring to FIG. 1, the memory system 110 receiving a read request inputted from the host 102 may perform a first operation corresponding to the read request. The controller 130 in the memory system 110 may include data input/output (I/O) control circuitry 198 that reads data from the memory device 150 and outputs the data to the host 102 in response to the read request. When the host 102 performs address translation between the logical address and the physical address, the controller 130 may receive the read request along with a logical address as well as a physical address. If the physical address transmitted with the read command is valid, the controller 130 may perform a read operation by using the physical address to access a specific location in the memory device 150, without performing a separate address translation. On the other hand, when the physical address inputted with the read command is not valid, the controller 130 performs an address translation to obtain a physical address corresponding to an inputted logical address. Then, the controller 130 performs the read operation using the obtained physical address for accessing the specific location in the memory device 150 based on the physical address obtained through the address translation.

In an implementation of the disclosed technology, the term ‘circuitry’ refers to at least one of the following: (a) hardware-only circuit implementations (such as implementations in only analog and/or digital circuitry), (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions), or (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. In an implementation, the term “circuitry” also covers an implementation of merely a processor (or multiple processors) or portion of a processor and its (or their) accompanying software and/or firmware. The term “circuitry” also covers, for example, an integrated circuit for a storage device.

The controller 130 can perform a high-speed read operation or a general read operation depending on whether the host 102 performs address translation or not. When the host 102 stores valid map data and the host 102 performs address translation instead of the controller 130, since the memory system 110 does not need to perform the address translation, the high-speed read operation of the data input/output (I/O) control circuitry 198 in the controller 130 can be performed by the memory system 110. Thus, a data input/output speed (e.g., I/O throughput) of the memory system 110 can be improved. When the host 102 does not store the valid mapping information, the memory system 110 needs to perform the address translation and the general read operation of the data input/output control circuitry 198 can be performed by the memory system 110. Therefore, transmitting valid mapping information from the memory system to the host 102 can allow the host 102 to perform address translation based on the valid mapping information, which results in improving the data input/output speed (e.g., I/O throughput).

Based on the high-speed read operation and the general read operation performed by the data input/output (I/O) control circuitry 198, the information collection circuitry 192 may select or collect map information to be transmitted to the host 102. By the way of example but not limitation, the information collection circuitry 192 can check a usage frequency of the map information which is used for address translation, while or after the general read operation including the address translation is performed by the data input/output (I/O) control circuitry 198. For example, the information collection circuitry 192 can determine a usage count for the map information used for address translation during a preset period. Recognizing frequently used map information based on the usage count, the controller 130 can provide the frequently used map information to the host 102. According to an embodiment, the information collection circuitry 192 might not care the high-speed read operation because the host 102 has already stored the valid mapping information which is used for transferring a physical address along with a corresponding logical address to the memory system 110. When the host 102 has already stored in the valid mapping information, it might be unnecessary that the memory system 110 transfers the mapping information to the host 102.

After the information collection circuitry 192 determines which map information is to be transmitted to the host 102, an operation determination circuitry 196 can check an operational state of the controller 130 or the data input/output control circuitry 198 to determine a transmission timing regarding determined or selected map information. The map information can be transmitted into the host 102 at a time point that does not lower or degrade the data input/output speed (e.g., I/O throughput) of the memory system 110. For example, the controller 130 can transfer the map information while not outputting data or signal corresponding to any read request or any write request inputted from the host 102.

The operations of the information collection circuitry 192 and the operation determination circuitry 196 can be performed separately and independently from an operation of the data input/output (I/O) control circuitry 198. This allows to avoid the degradation of the data input/output speed (e.g., I/O throughput) of the memory system 110. For example, when an operation performed by the data input/output (I/O) control circuitry 198 in response to a command (for example, a read request or a write request) transmitted from the host 102 is interfered, interrupted or delayed, the data input/output speed (e.g., I/O throughput) of the memory system 110 may be degraded. To avoid degradation of the data input/output speed, the operations of the information collection circuitry 192 and the operation determination circuitry 196 may be performed as a background operation. The background operation may use less resources of the memory system 110 or the controller 130 than a general operation or a foreground operation which is performed in response to a request entered from the host 102. The information collection circuitry 192 and the operation determination circuitry 196 are configured not to interfere the operation performed by the data input/output control circuitry 198. In an embodiment, the information collection circuitry 192 and the operation determination circuitry 196 can use different resources. For example, the information collection circuitry 192 and the operation determination circuitry 196 use a core, while the data input/output control circuitry 198 uses another core. Accordingly, it is possible to prevent the operation performed by the data input/output control circuitry 198 from being interfered with or limited by the operations of the information collection circuitry 192 and the operation determination circuitry 196.

In an embodiment, the operations of the information collection circuitry 192 and the operation determination circuitry 196 may be performed in different ways from the operation of the data input/output control circuitry 198. The information collection circuitry 192 and the operation determination circuitry 196 can operate, for example, based on a time sharing scheme, a time slicing scheme, or a time division scheme or others, by utilizing an operational margin that ensures that the data input/output control unit 198 is not interfered with the information collection circuitry 192 and the operation determination circuitry 196. For example, operations of the information collection circuitry 192 and the operation determination circuitry 196 may be performed as a parallel operation or a background operation. In another embodiment, operations of the information collection circuitry 192 and the operation determination circuitry 196 may be followed by an operation of the data input/output control circuitry 198 or concurrently performed with the operation of the data input/output control circuitry 198. Based on various schemes, the information collection circuitry 192 and the determination circuitry 196 may select or determine map information whose usage frequency is high, and transmit the selected or determined map information to the host 102 after or between operations performed by the data input/output control circuitry 198.

In an implementation, the memory system 110 transmitting at least some of the map information to the host 102 may generate a log or a history regarding the transmitted map information. The log or a history may have one of various formats, structures, marks, variables or types, and may be stored in a memory device or a storage area including nonvolatile memory cells. In an embodiment, whenever the memory system 110 transmits map information to the host 102, the transmitted map information may be recorded in the log or the history. In some implementation, the memory system 110 may determine an amount of transmitted map information to be recorded in the log or the history based on a size of map information that can be transmitted to the host 102. For example, it may be assumed that a size of map information that the memory system 110 can transmit to the host 102 is 512 KB. Although the memory system 110 may transmit more than 512 KB of map information to the host 102 in a log or a history, the amount of transmitted map information recorded in the log or the history may be limited to 512 KB. The amount of map information that memory system 110 can send to host 102 at one time may be less than the amount of map information that host 102 can store in the memory. For example, the map information may be transmitted to the host 102 in a segment unit. The memory system 110 may transfer segments of the map information to the host 102 through multiple transmissions, and the segments of the map information may be transmitted to the host 102 continuously or intermittently.

In an embodiment, when the memory system 110 transmits more than 1 MB of map information to the host 102, the host 102 can delete old map information that has been previously transmitted from the memory system 110 and stored in a memory. The map information deleted can be decided based on time information when such map information was sent from the memory system 110 to the host 102. In an implementation, the map information transmitted from the memory system 110 to the host 102 may include update information. Since a space allocated by the host 102 to store the map information transmitted from the memory system 110 includes volatile memory cells (an overwrite is supported), the host 102 can update map information based on the update information without an additional operation of erasing another map information.

The host 102 may add a physical address PBA into a command that is to be transmitted to the memory system 110 based on the map information. In the mapping operation, the host 102 can search for and find the physical address PBA in the map information stored in the memory, based on a logical address corresponding to a command to be transmitted to the memory system 110. When the physical address corresponding to the command exists and is found by the host 102, the host 102 may transmit the command with the logical address and the physical address to the memory system 110.

The memory system 110, which receives a command with a logical address and a physical address inputted from the host 102, may perform a command operation corresponding to the command. As described above, when the host 102 transfers a physical address corresponding to a read command, the memory system 110 can use the physical address to access and output data stored in a location indicated by the physical address. Thus, the memory system 110 can perform an operation in response to the read command by using the physical address received together with the read command from the host 102 without performing a separate address translation, the memory system 110 can reduce a time spent on the operation.

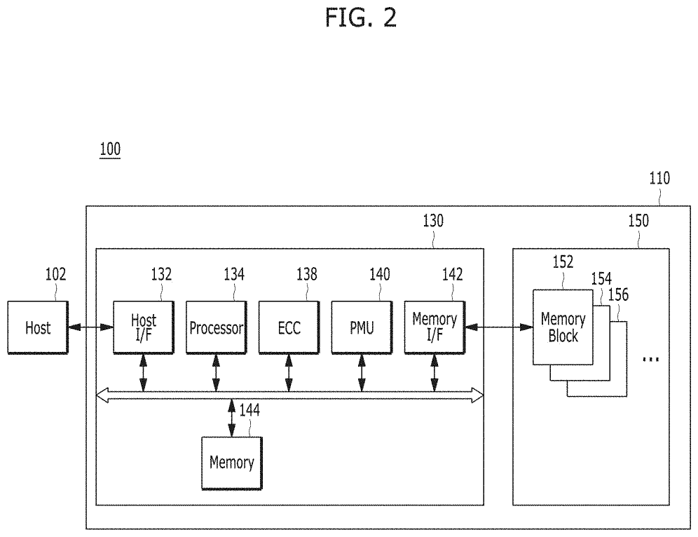

Referring to FIG. 2, a data processing system 100 in accordance with an embodiment of the disclosure is described. Referring to FIG. 2, the data processing system 100 may include a host 102 engaged or interlocked with a memory system 110.

The host 102 may include, for example, a portable electronic device such as a mobile phone, an MP3 player, or a laptop computer, or a non-portable electronic device such as a desktop computer, a game player, a television (TV), a projector, or others.

The host 102 also includes at least one operating system (OS), which can generally manage and control functions and operations performed in the host 102. The OS can provide interoperability between the host 102 engaged with the memory system 110 and the user using the memory system 110. The OS may support functions and operations corresponding to user's requests. By the way of example but not limitation, the OS can be classified into a general operating system and a mobile operating system according to mobility of the host 102. The general operating system may be split into a personal operating system and an enterprise operating system according to system requirements or a user's environment. But the enterprise operating systems can be specialized for securing and supporting high performance. The mobile operating system may be subject to support services or functions for mobility (e.g., a power saving function). The host 102 may include a plurality of operating systems. The host 102 may execute multiple operating systems interlocked with the memory system 110, corresponding to a user's request. The host 102 may transmit a plurality of commands corresponding to the user's requests into the memory system 110, thereby performing operations corresponding to commands within the memory system 110.

The controller 130 in the memory system 110 may control the memory device 150 in response to a request or a command inputted from the host 102. For example, the controller 130 may perform a read operation to provide data read from the memory device 150 for the host 102, and perform a write operation (or a program operation) to store data inputted from the host 102 in the memory device 150. In order to perform data input/output (I/O) operations, the controller 130 may control and manage various operations to read, program, erase, or others.

In an embodiment, the controller 130 can include a host interface 132, a processor 134, an error correction circuitry 138, a power management unit (PMU) 140, a memory interface 142, and a memory 144. Components included in the controller 130 described in FIG. 2 can be varied based on implementation forms, operation performances, or others. For example, the memory system 110 may be implemented with any one of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, or others. Components in the controller 130 may be added or omitted depending on implementation of the memory system 110.

The host 102 and the memory system 110 may include a controller or an interface for transmitting and receiving a signal, data, and others, under a predetermined protocol. For example, the host interface 132 in the memory system 110 may include an apparatus capable of transmitting a signal, data, and others to the host 102 or receiving a signal, data, and others inputted from the host 102.

The host interface 132 included in the controller 130 may receive a signal, a command (or a request), or data inputted from the host 102. The host 102 and the memory system 110 may use a predetermined protocol to transmit and receive data between the host 102 and the memory system 110. An example of protocols or interfaces, supported by the host 102 and the memory system 110 for sending and receiving a piece of data, can include Universal Serial Bus (USB), Multi-Media Card (MMC), Parallel Advanced Technology Attachment (PATA), Small Computer System Interface (SCSI), Enhanced Small Disk Interface (ESDI), Integrated Drive Electronics (IDE), Peripheral Component Interconnect Express (PCIE), Serial-attached SCSI (SAS), Serial Advanced Technology Attachment (SATA), Mobile Industry Processor Interface (MIPI), or others. In an embodiment, the host interface 132 may exchange data with the host 102 and is implemented with, or driven by, firmware called a host interface layer (HIL).

The Integrated Drive Electronics (IDE) or Advanced Technology Attachment (ATA), used as one of the interfaces for transmitting and receiving data, can use a cable including 40 wires connected in parallel to support data transmission and reception between the host 102 and the memory system 110. When a plurality of memory systems 110 are connected to a single host 102, the plurality of memory systems 110 may be divided into a master or a slave by using a position or a dip switch to which the plurality of memory systems 110 are connected. The memory system 110 set as the master may be used as the main memory device. The IDE (ATA) has evolved into Fast-ATA, ATAPI, and Enhanced IDE (EIDE).

Serial Advanced Technology Attachment (SATA) is a serial data communication interface that is compatible with various ATA standards of parallel data communication interfaces which is used by integrated Drive Electronics (IDE) devices. The fourty wires in the IDE interface can be reduced to six wires in the SATA interface. For example, 40 parallel signals for the IDE can be converted into 6 serial signals for the SATA to be transmitted between each other. The SATA has been widely used because of its faster data transmission and reception rate and its less resource consumption in the host 102 used for data transmission and reception. The SATA may support connection with up to 30 external devices to a single transceiver included in the host 102. In addition, the SATA can support hot plugging that allows an external device to be attached or detached from the host 102 even while data communication between the host 102 and another device is being executed. Thus, the memory system 110 can be connected or disconnected as an additional device, like a device supported by a universal serial bus (USB) even when the host 102 is powered on. For example, in the host 102 having an eSATA port, the memory system 110 may be freely detached like an external hard disk.

The Small Computer System Interface (SCSI) is a serial data communication interface used for connection between a computer, a server, and/or another peripheral device. The SCSI can provide a high transmission speed, as compared with other interfaces such as the IDE and the SATA. In the SCSI, the host 102 and at least one peripheral device (e.g., the memory system 110) are connected in series, but data transmission and reception between the host 102 and each peripheral device may be performed through a parallel data communication. In the SCSI, it is easy to connect to, or disconnect from, the host 102 a device such as the memory system 110. The SCSI can support connections of 15 other devices to a single transceiver included in host 102.

The Serial Attached SCSI (SAS) can be understood as a serial data communication version of the SCSI. In the SAS, not only the host 102 and a plurality of peripheral devices are connected in series, but also data transmission and reception between the host 102 and each peripheral device may be performed in a serial data communication scheme. The SAS can support connection between the host 102 and the peripheral device through a serial cable instead of a parallel cable, so as to easily manage equipment using the SAS and enhance or improve operational reliability and communication performance. The SAS may support connections of eight external devices to a single transceiver included in the host 102.

The Non-volatile memory express (NVMe) is a kind of interface based at least on a Peripheral Component Interconnect Express (PCIe) designed to increase performance and design flexibility of the host 102, servers, computing devices, and the like equipped with the non-volatile memory system 110. Here, the PCIe can use a slot or a specific cable for connecting the host 102, such as a computing device, and the memory system 110, such as a peripheral device. For example, the PCIe can use a plurality of pins (for example, 18 pins, 32 pins, 49 pins, 82 pins, etc.) and at least one wire (e.g. x1, x4, x8, x16, etc.), to achieve high speed data communication over several hundred MB per second (e.g. 250 MB/s, 500 MB/s, 984.6250 MB/s, 1969 MB/s, and etc.). According to an embodiment, the PCIe scheme may achieve bandwidths of tens to hundreds of Giga bits per second. A system using the NVMe can make the most of an operation speed of the nonvolatile memory system 110, such as an SSD, which operates at a higher speed than a hard disk.

In an embodiment, the host 102 and the memory system 110 may be connected through a universal serial bus (USB). The Universal Serial Bus (USB) is a kind of scalable, hot-pluggable plug-and-play serial interface that can provide cost-effective standard connectivity between the host 102 and a peripheral device such as a keyboard, a mouse, a joystick, a printer, a scanner, a storage device, a modem, a video camera, or others. A plurality of peripheral devices such as the memory system 110 may be coupled to a single transceiver included in the host 102.

Referring to FIG. 2, the error correction circuitry 138 can correct error bits of the data to be processed in (e.g., outputted from) the memory device 150, which may include an ECC encoder and an ECC decoder. Here, the ECC encoder can perform error correction encoding of data to be programmed in the memory device 150 to generate encoded data into which a parity bit is added and store the encoded data in memory device 150. The ECC decoder can detect and correct errors contained in a data read from the memory device 150 when the controller 130 reads the data stored in the memory device 150. In other words, after performing error correction decoding on the data read from the memory device 150, the ECC component 138 can determine whether the error correction decoding has succeeded and output an instruction signal (e.g., a correction success signal or a correction fail signal). The ECC component 138 can use the parity bit which is generated during the ECC encoding process, for correcting the error bit of the read data. When the number of the error bits is greater than or equal to a threshold number of correctable error bits, the ECC component 138 might not correct error bits but instead may output an error correction fail signal indicating failure in correcting the error bits.

In an embodiment, the error correction circuitry 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The error correction circuitry 138 may include and all circuits, modules, systems or devices for performing the error correction operation based on at least one of the above described codes.

The power management unit (PMU) 140 may control electrical power provided in the controller 130. The PMU 140 may monitor the electrical power supplied to the memory system 110 (e.g., a voltage supplied to the controller 130) and provide the electrical power to components included in the controller 130. The PMU 140 can not only detect power-on or power-off, but also generate a trigger signal to enable the memory system 110 to back up a current state urgently when the electrical power supplied to the memory system 110 is unstable. In an embodiment, the PMU 140 may include a device or a component capable of accumulating electrical power that may be used in an emergency.

The memory interface 142 may serve as an interface for handling commands and data transferred between the controller 130 and the memory device 150, to allow the controller 130 to control the memory device 150 in response to a command or a request inputted from the host 102. The memory interface 142 may generate a control signal for the memory device 150 and may process data inputted to, or outputted from, the memory device 150 under the control of the processor 134 in a case when the memory device 150 is a flash memory. For example, when the memory device 150 includes a NAND flash memory, the memory interface 142 includes a NAND flash controller (NFC). The memory interface 142 can provide an interface for handling commands and data between the controller 130 and the memory device 150. In accordance with an embodiment, the memory interface 142 can be implemented through, or driven by, firmware called a Flash Interface Layer (FIL) as a component for exchanging data with the memory device 150.

According to an embodiment, the memory interface 142 may support an open NAND flash interface (ONFi), a toggle mode or the like for data input/output with the memory device 150. For example, the ONFi may use a data path (e.g., a channel, a way, etc.) that includes at least one signal line capable of supporting bi-directional transmission and reception in a unit of 8-bit or 16-bit data. Data communication between the controller 130 and the memory device 150 can be achieved through at least one interface regarding an asynchronous single data rate (SDR), a synchronous double data rate (DDR), and a toggle double data rate (DDR).

The memory 144 may be a sort of working memory in the memory system 110 or the controller 130, while storing temporary or transactional data occurred or delivered for operations in the memory system 110 and the controller 130. For example, the memory 144 may temporarily store a piece of read data outputted from the memory device 150 in response to a request from the host 102, before the piece of read data is outputted to the host 102. In addition, the controller 130 may temporarily store a piece of write data inputted from the host 102 in the memory 144, before programming the piece of write data in the memory device 150. When the controller 130 controls operations such as data read, data write, data program, data erase or etc. of the memory device 150, a piece of data transmitted or generated between the controller 130 and the memory device 150 of the memory system 110 may be stored in the memory 144. In addition to the piece of read data or write data, the memory 144 may store information (e.g., map data, read requests, program requests, etc.) necessary for performing operations for inputting or outputting a piece of data between the host 102 and the memory device 150. According to an embodiment, the memory 144 may include a command queue, a program memory, a data memory, a write buffer/cache, a read buffer/cache, a data buffer/cache, a map buffer/cache, and the like.

In an embodiment, the memory 144 may be implemented with a volatile memory. For example, the memory 144 may be implemented with a static random access memory (SRAM), a dynamic random access memory (DRAM), or both. Although FIG. 2 illustrates, for example, the memory 144 disposed within the controller 130, the embodiments are not limited thereto. The memory 144 may be located within or external to the controller 130. For instance, the memory 144 may be embodied by an external volatile memory having a memory interface transferring data and/or signals between the memory 144 and the controller 130.

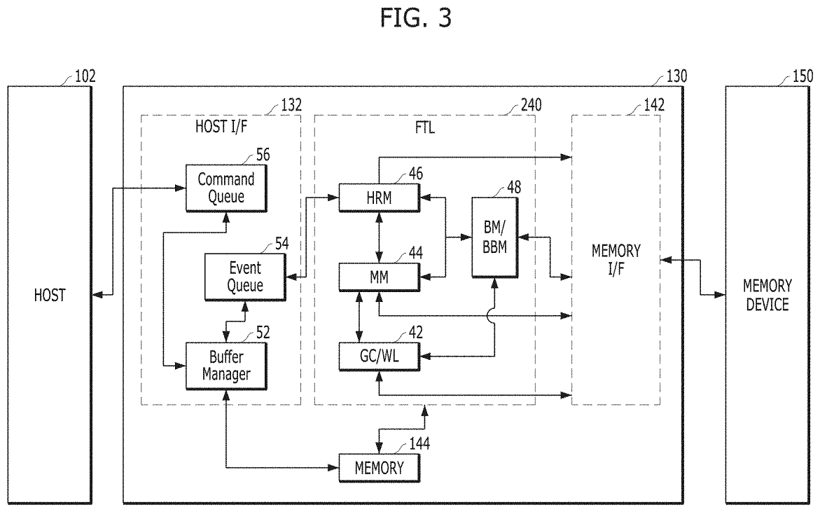

The processor 134 may control the overall operations of the memory system 110. For example, the processor 134 can control a program operation or a read operation of the memory device 150, in response to a write request or a read request entered from the host 102. According to an embodiment, the processor 134 may execute firmware to control the program operation or the read operation in the memory system 110. Herein, the firmware may be referred to as a flash translation layer (FTL). An example of the FTL is later described in detail, referring to FIG. 3. In an embodiment, the processor 134 may be implemented with a microprocessor or a central processing unit (CPU).

Further, In an embodiment, the memory system 110 may be implemented with at least one multi-core processor. The multi-core processor is, for example, a circuit or chip in which two or more cores, which are considered distinct processing regions, are integrated. For example, when a plurality of cores in the multi-core processor drive or execute a plurality of flash translation layers (FTLs) independently, data input/output speed (or performance) of the memory system 110 may be improved. According to an embodiment, the data input/output (I/O) control circuitry 198 and the information collection circuitry 192 described in FIG. 1 may be independently performed through different cores in the multi-core processor.

The processor 134 in the controller 130 may perform an operation corresponding to a request or a command inputted from the host 102. Further, the memory system 110 may be independent of a command or a request inputted from an external device such as the host 102. Typically, an operation performed by the controller 130 in response to the request or the command inputted from the host 102 may be considered a foreground operation, while an operation performed by the controller 130 independently (e.g., regardless of the request or the command inputted from the host 102) may be considered a background operation. The controller 130 can perform the foreground or background operation for read, write or program, erase and others regarding data in the memory device 150. In addition, a parameter set operation corresponding to a set parameter command or a set feature command as a set command transmitted from the host 102 may be considered a foreground operation. As a background operation without a command transmitted from the host 102, the controller 130 can perform garbage collection (GC), wear leveling (WL), bad block management for identifying and processing bad blocks, or others may be performed, in relation to a plurality of memory blocks 152, 154, 156 included in the memory device 150.

In an embodiment, substantially similar operations may be performed as both the foreground operation and the background operation. For example, if the memory system 110 performs garbage collection in response to a request or a command inputted from the host 102 (e.g., Manual GC), garbage collection can be considered a foreground operation. However, when the memory system 110 may perform garbage collection independently of the host 102 (e.g., Auto GC), garbage collection can be considered a background operation.

When the memory device 150 includes a plurality of dies (or a plurality of chips) including non-volatile memory cells, the controller 130 may be configured to perform a parallel processing regarding plural requests or commands inputted from the host 102 in to improve performance of the memory system 110. For example, the transmitted requests or commands may be divided into and processed simultaneously in a plurality of dies or a plurality of chips in the memory device 150. The memory interface 142 in the controller 130 may be connected to a plurality of dies or chips in the memory device 150 through at least one channel and at least one way. When the controller 130 distributes and stores pieces of data in the plurality of dies through each channel or each way in response to requests or commands associated with a plurality of pages including nonvolatile memory cells, plural operations corresponding to the requests or the commands can be performed simultaneously or in parallel. Such a processing method or scheme can be considered as an interleaving method. Because data input/output speed of the memory system 110 operating with the interleaving method may be faster than that without the interleaving method, data I/O performance of the memory system 110 can be improved.

By the way of example but not limitation, the controller 130 can recognize statuses regarding a plurality of channels (or ways) associated with a plurality of memory dies included in the memory device 150. The controller 130 may determine the state of each channel or each way as one of a busy state, a ready state, an active state, an idle state, a normal state and/or an abnormal state. The controller's determination of which channel or way an instruction (and/or a data) is delivered through can be associated with a physical block address, e.g., which die(s) the instruction (and/or the data) is delivered into. The controller 130 can refer to descriptors delivered from the memory device 150. The descriptors can include a block or page of parameters that describe something about the memory device 150, which is data with a predetermined format or structure. For instance, the descriptors may include device descriptors, configuration descriptors, unit descriptors, and others. The controller 130 can refer to, or use, the descriptors to determine which channel(s) or way(s) an instruction or a data is exchanged via.

Referring to FIG. 2, the memory device 150 in the memory system 110 may include the plurality of memory blocks 152, 154, 156. Each of the plurality of memory blocks 152, 154, 156 includes a plurality of nonvolatile memory cells. According to an embodiment, the memory block 152, 154, 156 can be a group of nonvolatile memory cells erased together. The memory block 152, 154, 156 may include a plurality of pages which is a group of nonvolatile memory cells read or programmed together. Although not shown in FIG. 2, each memory block 152, 154, 156 may have a three-dimensional stack structure for a high integration. Further, the memory device 150 may include a plurality of dies, each die including a plurality of planes, each plane including the plurality of memory blocks 152, 154, 156. Configuration of the memory device 150 can be different for performance of the memory system 110.

In the memory device 150 shown in FIG. 2, the plurality of memory blocks 152, 154, 156 are included. The plurality of memory blocks 152, 154, 156 can be any of different types of memory blocks such as a single level cell (SLC) memory block, a multi-level cell (MLC) Cell) memory block or others, according to the number of bits that can be stored or represented in one memory cell. In an implementation, the SLC memory block includes a plurality of pages implemented by memory cells, each storing one bit of data. The SLC memory block can have high data I/O operation performance and high durability. The MLC memory block includes a plurality of pages implemented by memory cells, each storing multi-bit data (e.g., two bits or more). The MLC memory block can have larger storage capacity for the same space compared to the SLC memory block. The MLC memory block can be highly integrated in a view of storage capacity. In an embodiment, the memory device 150 may be implemented with MLC memory blocks such as a double level cell (DLC) memory block, a triple level cell (TLC) memory block, a quadruple level cell (QLC) memory block and a combination thereof. The double level cell (DLC) memory block may include a plurality of pages implemented by memory cells, each capable of storing 2-bit data. The triple level cell (TLC) memory block can include a plurality of pages implemented by memory cells, each capable of storing 3-bit data. The quadruple level cell (QLC) memory block can include a plurality of pages implemented by memory cells, each capable of storing 4-bit data. In another embodiment, the memory device 150 can be implemented with a block including a plurality of pages implemented by memory cells, each capable of storing 5-bit or more bit data.

In an embodiment, the controller 130 may use a multi-level cell (MLC) memory block included in the memory system 150 as a SLC memory block that stores one-bit data in one memory cell. A data input/output speed of the multi-level cell (MLC) memory block can be slower than that of the SLC memory block. When the MLC memory block is used as the SLC memory block, a margin for a read or program operation can be reduced. The controller 130 can utilize a faster data input/output speed of the multi-level cell (MLC) memory block when using the multi-level cell (MLC) memory block as the SLC memory block. For example, the controller 130 can use the MLC memory block as a buffer to temporarily store a piece of data, because the buffer may require a high data input/output speed for improving performance of the memory system 110.

In an embodiment, the controller 130 may program pieces of data in a multi-level cell (MLC) a plurality of times without performing an erase operation on a specific MLC memory block included in the memory system 150. In general, nonvolatile memory cells have a feature that does not support data overwrite. The controller 130 may use a feature in which a multi-level cell (MLC) may store multi-bit data, in order to program plural pieces of 1-bit data in the MLC a plurality of times. For the MLC overwrite operation, the controller 130 may store the number of program times as separate operation information when a piece of 1-bit data is programmed in a nonvolatile memory cell. In an embodiment, an operation for uniformly levelling threshold voltages of nonvolatile memory cells can be carried out before another piece of data is overwritten in the same nonvolatile memory cells.

In an embodiment of the disclosed technology, the memory device 150 is embodied as a nonvolatile memory such as a flash memory such as a NAND flash memory, a NOR flash memory or others. Alternatively, the memory device 150 may be implemented by at least one of a phase change random access memory (PCRAM), a ferroelectrics random access memory (FRAM), a spin injection magnetic memory (STT-RAM), a spin transfer torque magnetic random access memory (STT-MRAM), or others.

Referring to FIG. 3, a controller in a memory system in accordance with another embodiment of the disclosed technology is described. The controller 130 cooperates with the host 102 and the memory device 150. As illustrated, the controller 130 includes a host interface 132, a flash translation layer (FTL) 240, as well as the host interface 132, the memory interface 142 and the memory 144. The controller 130 can be one previously described in connection with FIG. 2.

Although not shown in FIG. 3, in accordance with an embodiment, the ECC unit 138 described in FIG. 2 may be included in the flash translation layer (FTL) 240. In another embodiment, the ECC unit 138 may be implemented as a separate module, a circuit, firmware or others, which is included in, or associated with, the controller 130.

The host interface 132 is for handling commands, data, and others transmitted from the host 102. By way of example but not limitation, the host interface 132 may include a command queue 56, a buffer manager 52 and an event queue 54. The command queue 56 may sequentially store commands, data, and others received from the host 102 and output them to the buffer manager 52 in an order in which they are stored. The buffer manager 52 may classify, manage or adjust the commands, the data, and the like, which are received from the command queue 56. The event queue 54 may sequentially transmit events for processing the commands, the data, and the like received from the buffer manager 52.

A plurality of commands or data of the same characteristic, e.g., read or write commands, may be transmitted from the host 102, or commands and data of different characteristics may be transmitted to the memory system 110 after being mixed or jumbled by the host 102. For example, a plurality of commands for reading data (read commands) may be delivered, or commands for reading data (read command) and programming/writing data (write command) may be alternately transmitted to the memory system 110. The host interface 132 may store commands, data, and others, which are transmitted from the host 102, to the command queue 56 sequentially. Thereafter, the host interface 132 may estimate or predict what kind of internal operation the controller 130 will perform based on the characteristics of commands, data, and others, which have been entered from the host 102. The host interface 132 can determine a processing order and a priority of commands, data and others, based at least on their characteristics. Based on characteristics of commands, data, and the like transmitted from the host 102, the buffer manager 52 in the host interface 132 is configured to determine whether the buffer manager needs to store commands, data, and others in the memory 144, or whether the buffer manager needs to deliver the commands, the data, and others to the flash translation layer (FTL) 240. The event queue 54 receives events, entered from the buffer manager 52, which are to be internally executed and processed by the memory system 110 or the controller 130 in response to the commands, the data, and others transmitted from the host 102, so as to deliver the events to the flash translation layer (FTL) 240 in the order received.

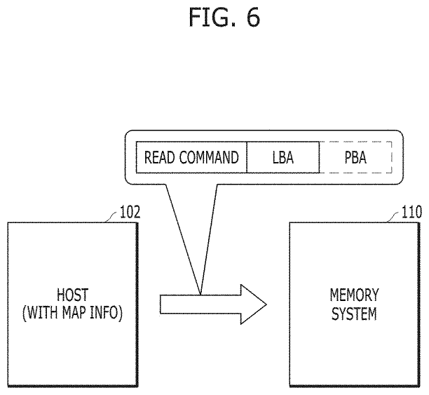

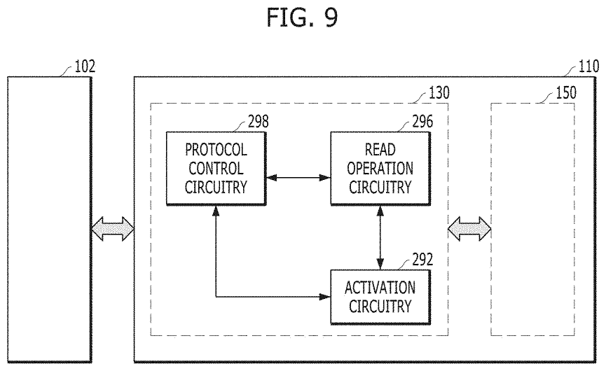

In accordance with an embodiment, the flash translation layer (FTL) 240 described in FIG. 3 may perform some functions of the data input/output (I/O) control circuitry 198 and the information collection circuitry 192 described in FIG. 1. Further, the host interface 132 may set a host memory 106 in the host 102, which is shown in FIG. 6 or 9, as a slave and add the host memory 106 as an additional storage space which is controllable or usable by the controller 130.

In accordance with an embodiment, the flash translation layer (FTL) 240 can include a host request manager (HRM) 46, a map manager (MM) 44, a state manager 42 and a block manager 48. The host request manager (HRM) 46 can manage the events entered from the event queue 54. The map manager (MM) 44 can handle or control a map data. The state manager 42 can perform garbage collection (GC) or wear leveling (WL). The garbage collection may refer to a form of memory management, in which a garbage collector attempts to reclaim (garbage) memory that is occupied by objects that are no longer in use. The wear leveling indicates techniques for prolonging lifetime of erasable storage devices. The block manager 48 can execute commands or instructions onto a block in the memory device 150.

By way of example but not limitation, the host request manager (HRM) 46 can use the map manager (MM) 44 and the block manager 48 to handle or process requests based on the read and program commands, and events which are delivered from the host interface 132. The host request manager (HRM) 46 can send an inquiry request to the map data manager (MM) 44, to determine a physical address corresponding to the logical address which is entered with the events. The host request manager (HRM) 46 can send a read request with the physical address to the memory interface 142, to process the read request (handle the events). The host request manager (HRM) 46 can send a program request (write request) to the block manager 48, to program data to a specific empty page (no data) in the memory device 150, and then, can transmit a map update request corresponding to the program request to the map manager (MM) 44, to update an item relevant to the programmed data in information of mapping the logical-physical addresses to each other.

In an implementation, the block manager 48 can convert a program request delivered from the host request manager (HRM) 46, the map data manager (MM) 44, and/or the state manager 42 into a flash program request used for the memory device 150, to manage flash blocks in the memory device 150. In order to maximize or enhance program or write performance of the memory system 110 (see FIG. 2), the block manager 48 may collect program requests and send flash program requests for multiple-plane and one-shot program operations to the memory interface 142. In an embodiment, the block manager 48 sends several flash program requests to the memory interface 142 to enhance or maximize parallel processing of the multi-channel and multi-directional flash controller.

In an implementation, the block manager 48 can be configured to manage blocks in the memory device 150 based on the number of valid pages, select and erase blocks having no valid pages when a free block is needed, and select a block including the least number of valid pages when it is determined that garbage collection is necessary. The state manager 42 can perform garbage collection to move the valid data to an empty block and erase the blocks containing the moved valid data so that the block manager 48 may have enough free blocks (empty blocks with no data). If the block manager 48 provides information regarding a block to be erased to the state manager 42, the state manager 42 could check all flash pages of the block to be erased to determine whether each page is valid. For example, to determine validity of each page, the state manager 42 can identify a logical address recorded in an out-of-band (OOB) area of each page. To determine whether each page is valid, the state manager 42 can compare the physical address of the page with the physical address mapped to the logical address obtained from the inquiry request. The state manager 42 sends a program request to the block manager 48 for each valid page. A mapping table can be updated through the update of the map manager 44 when the program operation is complete.

The map manager 44 can manage a logical-physical mapping table. The map manager 44 can process requests such as queries, updates, and others, which are generated by the host request manager (HRM) 46 or the state manager 42. The map manager 44 may store the entire mapping table in the memory device 150 (e.g., a flash/non-volatile memory) and cache mapping entries according to the storage capacity of the memory 144. When a map cache miss occurs while processing inquiry or update requests, the map manager 44 may send a read request to the memory interface 142 to load a relevant mapping table stored in the memory device 150. When the number of dirty cache blocks in the map manager 44 exceeds a certain threshold, a program request can be sent to the block manager 48 so that a clean cache block is made and the dirty map table may be stored in the memory device 150.

When garbage collection is performed, the state manager 42 copies valid page(s) into a free block, and the host request manager (HRM) 46 can program the latest version of the data for the same logical address of the page and currently issue an update request. When the status manager 42 requests the map update in a state in which copying of valid page(s) is not completed normally, the map manager 44 might not perform the mapping table update. It is because the map request is issued with old physical information if the status manger 42 requests a map update and a valid page copy is completed later. The map manager 44 may perform a map update operation only if the latest map table still points to the old physical address in order to ensure accuracy.

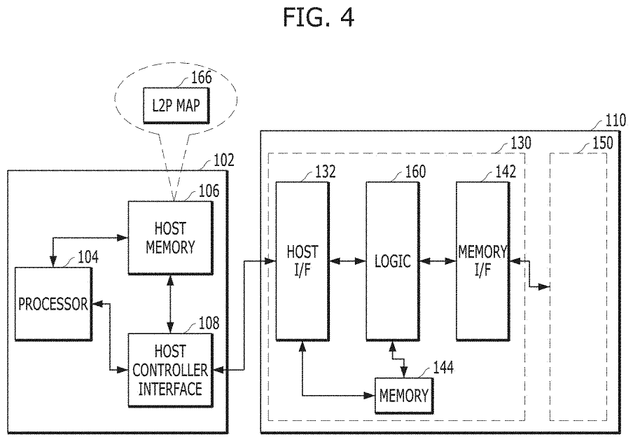

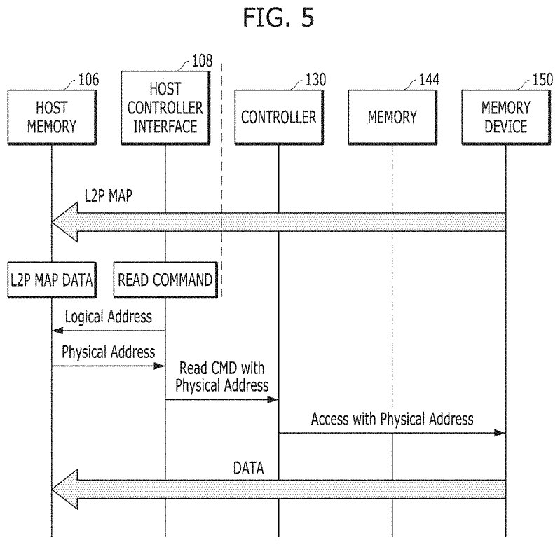

FIGS. 4 and 5 illustrate a case where a part of a memory included in a host can be used as a cache device for storing metadata used in the memory system.

Referring to FIG. 4, the host 102 may include a processor 104, a host memory 106, and a host controller interface 108. The memory system 110 may include a controller 130 and a memory device 150. Herein, the controller 130 and the memory device 150 described in FIG. 4 may correspond to the controller 130 and the memory device 150 described in FIGS. 1 to 3.

Hereinafter, a difference between the controller 130 and the memory device 150 shown in FIG. 4 and the controller 130 and the memory device 150 shown in FIGS. 1 to 3, which can technically be distinguished, is mainly described. For example, a logic block 160 in the controller 130 may correspond to the flash translation layer (FTL) 240 described in FIG. 3. In an embodiment, the logic block 160 in the controller 130 may work as an additional role and perform an additional function not described in the flash translation layer (FTL) 240 shown in FIG. 3.

The host 102 may include the processor 104, which has a higher performance than that of the memory system 110, and the host memory 106 which is capable of storing a larger amount of data than that of the memory system 110 that cooperates with the host 102. The processor 104 and the host memory 106 in the host 102 can have an advantage in terms of space and upgrade. For example, the processor 104 and the host memory 106 can have less space limitation than the processor 134 and the memory 144 in the memory system 110. The processor 104 and the host memory 106 can be upgraded to improve their performance, which is distinguishable from the processor 134 and the memory 144 in the memory system 110. In the embodiment, the memory system 110 can utilize the resources possessed by the host 102 in order to increase the operation efficiency of the memory system 110.

As an amount of data which can be stored in the memory system 110 increases, an amount of metadata corresponding to the data stored in the memory system 110 also increases. When storage capability used to load the metadata in the memory 144 of the controller 130 is limited or restricted, the increase in an amount of loaded metadata may cause an operational burden on operations of the controller 130. For example, because of limitation of space or region allocated for metadata in the memory 144 of the controller 130, only a part of the metadata may be loaded. If loaded metadata does not include a specific metadata for a physical location to which the host 102 is intended to access, the controller 130 needs to store, in the memory device 150, the loaded metadata some of which has been updated and the controller 130 also needs to load the specific metadata for the physical location to which the host 102 is intended to access. These operations are necessary for the controller 130 to perform a read operation or a write operation required by the host 102, which can cause the degradation on performance of the memory system 110.

Storage capability of the host memory 106 included in the host 102 may be greater tens or hundreds of times than that of the memory 144 included in the controller 130. The memory system 110 may transfer a metadata 166 used by the controller 130 to the host memory 106 in the host 102 so that at least some part of the host memory 106 in the host 102 may be accessed by the memory system 110. The at least some part of the host memory 106 can be used as a cache memory for address translation required for reading or writing data in the memory system 110. In this case, the host 102 translates a logical address into a physical address based on the metadata 166 stored in the host memory 106 before transmitting the logical address along with a request, a command or an instruction to the memory system 110. Then, the host 102 can transmit the translated physical address with the request, the command or the instruction to the memory system 110. The memory system 110, which receives the translated physical address with the request, the command or the instruction, may skip an internal process of translating the logical address into the physical address and access the memory device 150 based on the physical address transferred. In this case, an overhead (e.g., operational burden) that the controller 130 loads metadata from the memory device 150 for the address translation can be significantly reduced or gone, and operational efficiency of the memory system 110 can be enhanced.

Even if the memory system 110 transmits the metadata 166 to the host 102, the memory system 110 can control or manage information related to the metadata 166 such as generation, erase, and update of metadata. The controller 130 in the memory system 110 may perform a background operation such as garbage collection and wear leveling based on an operation state of the memory device 150 and can determine a physical address, i.e., the physical location in which the memory device 150 for data transferred from the host 102 is stored. Because a physical address of data stored in the memory device 150 can be changed and the host 102 does not know the changed physical address, the memory system 110 is configured to control or manage the information related to metadata 166.

While the memory system 110 controls or manage metadata used for the address translation, the memory system 110 can determined whether it is necessary to modify or update the metadata 166 previously transmitted to the host 102. If the memory system 110 determines that it is necessary to modify or update the metadata 166 previously transmitted to the host 102, the memory system 110 can send a signal or a metadata to the host 102 so as to request the update of the metadata 166 stored in the host 102. The host 102 may update the stored metadata 166 in the host memory 106 in response to a request delivered from the memory system 110. This allows the metadata 166 stored in the host memory 106 in the host 102 to be kept as the latest version such that, and the operation can proceed without errors even though the host controller interface 108 uses the metadata 166 stored in the host memory 106, to translate a logical address into a physical address to be transmitted along with the logical address to the memory system 110.

The metadata 166 stored in the host memory 106 may include mapping information used for translating a logical address into a physical address. Referring to FIG. 4, metadata associating a logical address with a physical address may include two items: a first mapping information used for translating a logical address into a physical address; and a second mapping information used for translating a physical address into a logical address. Among them, the metadata 166 stored in the host memory 106 may include the first mapping information. The second mapping information can be primarily used for internal operations of the memory system 110, but might not be used for operations requested by the host 102 to store data in the memory system 110 or read data corresponding to a particular logical address from the memory system 110. Depending on an embodiment, the second mapping information may be not transmitted by the memory system 110 to the host 102.

The controller 130 in the memory system 110 can control (e.g., create, delete, update, etc.) the first mapping information or the second mapping information, and store either the first mapping information or the second mapping information in the memory device 150. Because the host memory 106 in the host 102 is a volatile memory, the metadata 166 stored in the host memory 106 may disappear when an event such as interruption of power supply to the host 102 and the memory system 110 occurs. Accordingly, the controller 130 in the memory system 110 keep the latest state of the metadata 166 stored in the host memory 106 of the host 102, and also store the first mapping information or the second mapping information in the memory device 150. The first mapping information or the second mapping information stored in the memory device 150 can be the most recent one.

Referring to FIGS. 4 and 5, an operation requested by the host 102 to read data stored in the memory system 110 is described when the metadata 166 is stored in the host memory 106 of the host 102.

Power is supplied to the host 102 and the memory system 110, and then the host 102 and the memory system 110 can be engaged with each other. When the host 102 and the memory system 110 cooperate, the metadata (L2P MAP) stored in the memory device 150 can be transferred to the host host memory 106.

When a read command (Read CMD) is issued by the processor 104 in the host 102, the read command is transmitted to the host controller interface 108. After receiving the read command, the host controller interface 108 searches for a physical address corresponding to a logical address corresponding to the read command in the metadata (L2P MAP) stored in the host memory 106. Based on the metadata (L2P MAP) stored in the host memory 106, the host controller interface 108 can recognize the physical address corresponding to the logical address. The host controller interface 108 carries out an address translation for the logical address associated with the read command.

The host controller interface 108 transfers the read command (Read CMD) with the logical address as well as the physical address to the controller 130 of the memory system 110. The controller 130 can access the memory device 150 based on the physical address transferred with the read command. Data stored at a location corresponding to the physical address in the memory device 150 can be transferred to the host memory 106 in response to the read command (Read CMD).

An operation of reading data stored in the memory device 150 including a nonvolatile memory may take more time than an operation of reading data stored in the host memory 106 which is a volatile memory. In the above-described read operation performed in response to the read command (Read CMD), since the controller 130 receives the physical address with the read command (Read CMD), the controller 130 can skip or omit an address translation to search for a physical address corresponding to the logical address provided from the host 102. For example, the controller 130 does not have to load metadata from the memory device 150 or replace the metadata stored in the memory 144 when the controller 130 cannot find metadata for the address translation in the memory 144. This allows the memory system 110 to perform a read operation requested by the host 102 more quickly.

FIG. 6 illustrates a first example of a transaction between a host 102 and a memory system 110 in a data processing system according to an embodiment of the disclosed technology.

Referring to FIG. 6, the host 102 storing the map information (MAP INFO) may transmit a read command including a logical address LBA and a physical address PBA to the memory system 110. When a physical address PBA corresponding to a logical address LBA transmitted to the memory system 110 with a read command (READ COMMAND) is found in the map information stored in the host 102, the host 102 can transmit, to the memory system 110, the read command (READ COMMAND) with the logical address LBA and the physical address PBA. When the physical address PBA corresponding to the logical address LBA transmitted with the read command (READ COMMAND) is not found in the map information stored by the host 102, the host 102 may transmit, to the memory system 110, the read command (READ COMMAND) including the logical address LBA only without the physical address PBA.

Although FIG. 6 describes an operation in response to the read command (READ COMMAND) as an example, an embodiment of the disclosed technology can be applied to a write command or an erase command transferred from the host 102 to the memory system 110.

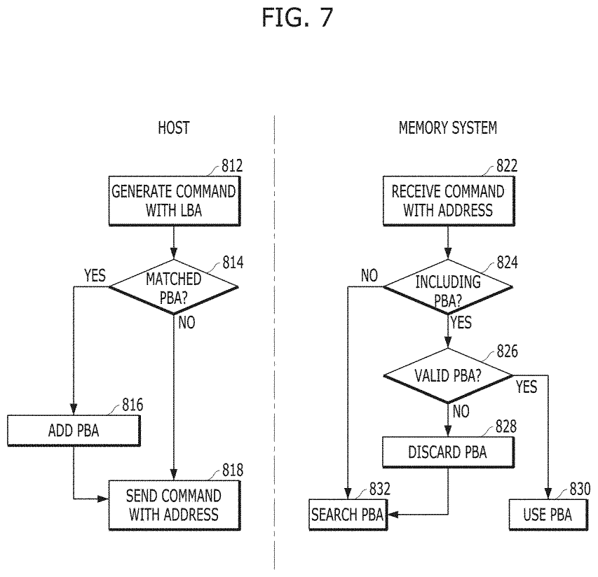

FIG. 7 illustrates a first operation of a host and a memory system according to an embodiment of the disclosed technology. FIG. 7 illustrates detailed operations of the host transmitting a command including a logical address LBA and a physical address PBA and the memory system receiving the command with the logical address LBA and the physical address PBA. The operations as shown in FIG. 7 can be performed by the host 102 and the memory system 110 as shown in FIG. 6.

Referring to FIG. 7, the host may generate a command COMMAND including a logical address LBA (step 812). Thereafter, the host may check whether a physical address PBA corresponding to the logical address LBA is in the map information (step 814). If there is no physical address PBA (NO in step 814), the host may transmit a command COMMAND including the logical address LBA without the physical address PBA (step 818).

On the other hand, if there is the physical address PBA (YES of step 814), the host may add the physical address PBA to the command COMMAND including the logical address LBA (step 816). The host may transmit the command COMMAND including the logical address LBA and the physical address PBA (step 818).

The memory system may receive a command which is transmitted from an external device such as the host (step 822). The memory system may check whether the command is provided with a physical address PBA (step 824). When the command does not include a physical address PBA (NO in step 824), the memory system may perform a mapping operation or an address translation, e.g., search for a physical address corresponding to the logical address inputted with the command (step 832).

When the command includes the physical address PBA (YES of step 824), the memory system may check whether the physical address PBA is valid (step 826). The validity of the physical address PBA is checked to avoid using the physical address PBA that is not valid. The host may perform the mapping operation based on the map information delivered from the memory system. After performing the mapping operation, the host may transmit the command with the physical address PBA to the memory system. In some cases, after the memory system transmits map information to the host, there may be some changes or updates on the map information managed or controlled by the memory system. In this case, the map information which has been delivered to the host before such changes or updates is not valid any longer, the physical address PBA obtained based on such old map information and delivered from the host is not valid either and cannot be used to access data. Thus, the determining of the validity of the physical address corresponds to the determining whether any changes or updates have occurred on map information used for the address translation to obtain the physical address PBA. When the physical address PBA provided with the command is valid (YES at step 826), the memory system may perform an operation corresponding to the command using the physical address PBA (step 830).

When the physical address PBA provided with the command is not valid (NO in step 826), the memory system may ignore the physical address PBA provided with the command (step 828). In this case, the memory system may search for a physical address PBA based on the logical address LBA inputted with the command (step 832).

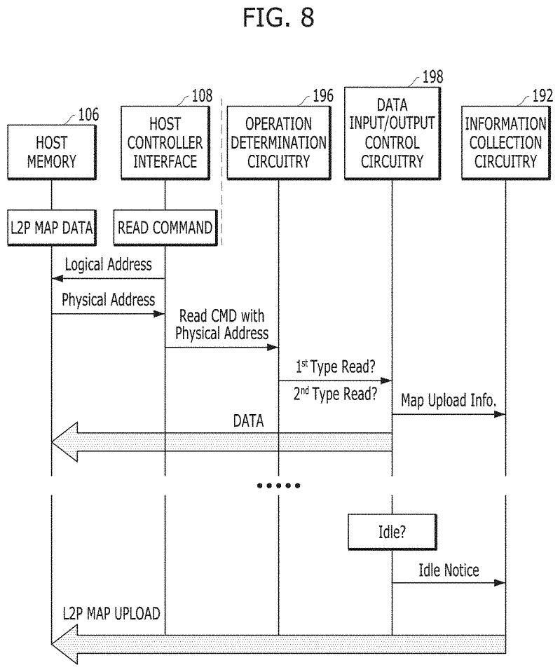

FIG. 8 illustrates an operation of determining and transmitting map information according to an embodiment of the disclosed technology. Referring to FIG. 5, when the host 102 and the memory system 110 are operatively engaged with each other, metadata (L2P MAP) stored in the memory device 150 may be transmitted to the host memory 106. In FIG. 8, it is assumed that the metadata (L2P MAP) is stored in the host memory 106.

Referring to FIG. 8, when a read command is generated by the processor 104 in the host 102, the read command is transmitted to the host controller interface 108. After receiving the read command, the host controller interface 108 can transmit a logical address corresponding to the read command to the host memory 106. Based on the metadata (L2P MAP) stored in the host memory 106, the host controller interface 108 may recognize a physical address corresponding to the logical address.

The host controller interface 108 transmits a read command (Read CMD) along with a physical address to the controller 130 (see FIGS. 1 to 3) in the memory system 110. The data input/output control circuitry 198 shown in FIG. 1 may receive the read command (Read CMD) transferred from the host controller interface 108 and access the memory device 150 based on the read command and the logical address (or the physical address). As described with reference to FIG. 1, when the data input/output control circuitry 198 can use the physical address transferred from the host controller interface 108, the data input/output control circuitry 198 may perform a fast read operation (i.e., 1^{st} type read operation) without address translation regarding the inputted logical address. If the physical address inputted from the host controller interface 108 is not valid, the data input/output control circuitry 198 can perform address translation regarding the logical address inputted from the host controller interface 108 for read operation corresponding to the read command. A general read operation (i.e., 2^{nd} type read operation) may be performed based on the translated physical address. Accordingly, the data input/output control circuitry 198 may transmit to the host memory 106 a piece of data stored in a specific location corresponding to the physical address in the memory device 150 through the fast read operation (i.e., 1^{st} type read operation) or the general read operation (i.e., 2^{nd} type read operation).

The process performed by the controller for reading some pieces of data from the memory device 150 including nonvolatile memory cells may take much longer than the process performed by the host controller interface for reading data from the host memory 106 that is a volatile memory. In a procedure performed by the controller 130, it may not be necessary that the controller 130 reads and loads metadata relevant to an inputted logical address from the memory device 150 for finding out the physical address. As a result, the procedure of reading a piece of data stored in the memory system 110 by the host 102 may be faster than the general read operation. Hereinafter, a read operation without controller's address translation is referred as to the fast read operation (i.e., 1^{st} type read operation) which is distinguished from the general read operation (i.e., 2^{nd} type read operation) including controller's address translation.

The data input/output control circuitry 198 can determine whether the fast read operation (1^{st} type read operation) or the general read operation (2^{nd} type read operation) has been performed in response to the read command (Read CMD) provided from the host 102. In addition, when the data input/output control circuitry 198 performs the address translation, map information used for the address translation may be notified to the information collection circuitry 192 as a candidate for upload map information (Map Upload Info).

In an embodiment, the controller 130 may recognize a piece of the map information used to perform the address translation by setting a count associated with the piece of map information and then increasing or managing the count. The piece of the map information used to perform the address translation can be recognized as the upload map information. The information collection circuitry 192 may increase the count corresponding to the piece of map information and select the piece of map information frequently or recently used by the data input/output control circuitry 198. The selected piece of map information can be transmitted to the host memory 106. The data input/output control circuitry 198 can transmit, to the information collection circuitry 192, information regarding what kind of read operation is performed in response to the read command (Read CMD) transferred from the host 102. Based on this information, the information collection circuitry 192 operating in a background operation may determine which piece of map information is to be transmitted to the host 102.

When there is no command transmitted from the host 102, the data input/output control circuitry 198 may be in an idle state. When the data input/output control circuitry 198 enters the idle state, the data input/output control circuitry 198 may notify the operation determination circuitry 196 that the data input/output control circuitry 198 is in the idle state. In an embodiment, the operation determination circuitry 196 may monitor an operation (or an operational state) of the data input/output control circuitry 198 to determine whether the data input/output control circuitry 198 is ready to send the piece of map information.

When the data input/output controller 198 is in an idle state, the operation determination circuitry 196 may transmit the piece of map information prepared or selected by the information collection circuitry 192 to the host memory 106. Since the operation determination circuitry 196 transmits the piece of map information to the host memory 106 while the data input/output control circuitry 198 is in an idle state, disruption can be reduced or minimized in performing a read operation of the memory system 110 in response to the read command (Read CMD) transferred from the host 102.

FIG. 9 illustrates a second example of an apparatus for determining and transmitting map information to be shared between the host 102 and the memory system 110 according to an embodiment of the disclosed technology.

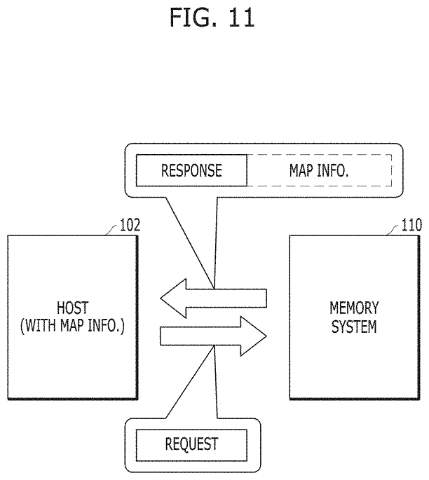

Referring to FIG. 9, the memory system 110 may include a controller 130 and a memory device 150. The controller 130 may include protocol control circuitry 298, read operation circuitry 296, and activation circuitry 292. Here, the protocol control circuitry 298 may perform some of operations carried out by the host interface 132 described with reference to FIGS. 2 to 3. The protocol control circuitry 298 may control data communication between the host 102 and the memory system 110. For example, the protocol control circuitry 298 may control an input buffer for storing commands, addresses, data or etc. transferred from the host 102 and an output buffer for storing a piece of data outputted to the host 102. The protocol control circuitry 298 may estimate or predict whether the controller 130 is going to entry in an idle state, and may find a time point at which the activation circuitry 292 transmits a piece of map information to the host 102. The time point at which the map information is transmitted may be determined based on data communication between the protocol control circuitry 298 and the host 102, which will be described below with reference to FIGS. 11 to 13.

An operation corresponding to the read command received through the protocol control circuitry 298 may be performed by the read operation circuitry 296. Here, the read operation circuitry 296 may correspond to the data input/output control circuitry 198 described with reference to FIG. 1. In FIG. 9, a read operation corresponding to a read command will be described. In response to the read command transmitted from the host 102, the read operation circuitry 296 may perform either a fast read operation or a general read operation.

While the read operation circuitry 296 performs the fast read operation or the general read operation, or after the read operation circuitry 296 performs the fast read operation or the general read operation, the activation circuitry 292 can select or determine a piece of map information to be transmitted to the host 102, in response to the read operation performed by the read operation circuitry 296.

The activation circuitry 292 and the read operation circuitry 296 can work independently of each other. The activation circuitry 292 may select and determine a piece of map information as a background operation, while the read operation circuitry 296 performs a read operation as a foreground operation. In an embodiment, the activation circuitry 292 may generate a piece of information having a specific data structure which corresponds to the existing metadata or the existing map information. For example, the map information may be divided into plural units (or segments), each unit transmitted to the host 102 at one time. The controller 130 may divide all pieces of map information, which can be used for address translation, into plural units of map information, which can be transmitted to the host 102. Accordingly, the number of pieces of information (e.g., the number of counts) generated by the activation circuitry 292 can be determined. In an embodiment, each count may be set or allocated for each piece of data having a predetermined size (e.g., a few bits, a few bytes or etc.) or each unit of map information. For the information generated or controlled by the activation circuitry 292, a space in the memory 144 (see FIGS. 2 to 3) may be allocated. For example, a space of 400 bytes based on a size of each index (for example, 4 bytes) and the number of the indices (for example, 100) for each unit of map information may be allocated.

The memory system 110 may increase a count regarding each unit of map information used for a read operation (address translation) in response to a read command transferred from the host. If the count may be compared with a predetermined criterion or a reference value, it is determined which unit of map information is transmitted. In an embodiment, the controller 130 can use an identifier indicating whether corresponding unit of map information is transmitted. With the identifier, the activation circuitry 292 may check which unit of map data is added or removed in a group of candidates to be transmitted to the host 102. For example, it is assumed that 80 pieces among total 100 pieces of map information are used for plural read operations. The activation circuitry 292 may generate information having a size of 320 bytes based on a size of index (e.g., 4 bytes) and the number of information pieces (e.g., 80). Thus, a small space (e.g., 320 bytes) in the memory 144 may be occupied. Since the information generated by the activator 292 occupies a small amount of resources in the controller 130, it is possible to reduce interference of data input/output operations performed by the memory system 110.

In an embodiment, after the read operation (e.g., SCSI CMD operation) performed by the read operation circuitry 296 is completed, the activation circuitry 292 may operate independently in the background. The activation circuitry 292 may set an additional information (e.g., counts) having a specific data structure and increase a count associated with a unit of map information used for address translation of the read operation. When the count exceeds the predetermined criterion, the activation circuitry 292 can determine that it is necessary to transmit a unit of map information corresponding to the host 102. Thereafter, the activation circuitry 292 may load and store the corresponding map information in a buffer (e.g., a queue) that can be outputted to the host 102.

When the unit of map information to be outputted to the host 102 is selected and determined, the activation circuitry 292 may reset or initialize the count corresponding to the unit of map information. This initialization can dynamically reflect a usage pattern or an access pattern regarding data stored in the memory system 110, to reduce address translation performed by read operation circuitry 296 during read operations. Further, it can be avoided that the memory system 110 send the unit of map information which the host memory 106 has stored to the host 102. Accordingly, overheads caused by sharing the map information between the memory system 110 and the host 102 can be reduced, and it is more effective to improve data input/output performance of the memory system 110. After the protocol control circuitry 298 confirms that the controller 130 is in the idle state, the controller 130 may output a selected unit of map information stored in the buffer to the host 102.

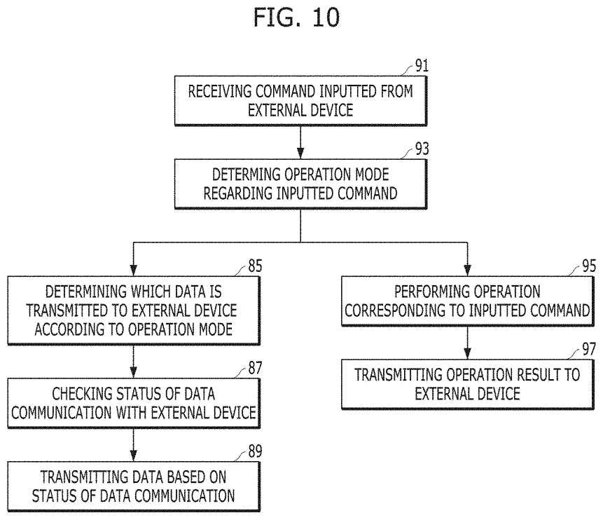

FIG. 10 illustrates an operation of a memory system according to an embodiment of the disclosure.

Referring to FIG. 10, a method for operating a memory system may include receiving a command inputted from an external device (step 91) and determining an operation mode regarding inputted command (step 93). Referring to FIGS. 1 to 9, an example of the command inputted from the external device may include a read command inputted from the host 102. The operation mode regarding the inputted command may be different in response to the logical address or the physical address inputted along with the read command. For example, the operation mode may be divided into a fast read operation and a general read operation.

When the operation mode of the command received by the memory system is determined (step 93), two operations, e.g., a foreground operation and a background operation, may be performed separately and independently. After the operation mode of the command is determined, the foreground operation including an operation corresponding to the command may be performed according to the operation mode (step 95). For example, either the fast read operation or the general read operation may be performed in the memory system 110 shown in FIGS. 1-3 and 9.

Thereafter, an operation result, i.e., a result of the foreground operation, may be transmitted to the external device (step 97). For example, either the fast read operation or the general read operation may be performed, and a piece of data read from the memory device 150 may be then transferred into the host 102.

In a step 85, as a background operation, information to be transmitted to the external device may be determined in response to the determined operation mode. For example, the transmitted information is determined according to which one of the fast read operation or the normal read operation was performed in response to a read command inputted from the host 102, or according to which map information corresponding to the general read operation is used for address translation. Depending on whether map information or the like is used for the address translation or whether map information is valid or updated, it is possible for the controller 130 to determine or select which map information is transferred into the host 102. After determining or selecting a unit of map information to be transmitted to the host 102, the controller 130 can reset or initialize data such as counts regarding the selected or determined map information.

In the background operation, when information to be transmitted to the external device is determined (step 85), the controller 130 may check an operation status of data communication with the external device (step 87). If the data communication is actively performed between the external device and the memory system 110, the controller 130 might not transmit the information to the external device. The controller 130 can delay a process for transmitting the selected or determined information to the external device to avoid interruption to transmit a piece of data as a result of data input/output (I/O) operation. Accordingly, the data input/output (I/O) speed of the memory system 110 might be not slowed down.

Thereafter, in response to an operation state of the data communication, the memory system 110 may transmit the selected or determined information to the external device (step 89). For example, when the memory system 110 is in an idle state, the memory system 110 may transmit a unit of map information, which has selected, collected or determined in advance, to the host 102.

As described above, the memory system 110 can separately and independently perform the foreground operation for data input/output (I/O) operation and the background operation to share map information with the host 102 so that a data input/output rate (e.g., I/O throughput) of the memory system 110 might be not decreased.

FIG. 11 illustrates a second example of a transaction between a host and a memory system in a data processing system according to an embodiment of the disclosed technology.

Referring to FIG. 11, the memory system 110 may transfer map information (MAP INFO) to the host 102. The host 102 may request the map information (MAP INFO) from the memory system 110. The memory system 110 may use a response RESPONSE regarding the command of the host 102 to transfer the map information (MAP INFO). Herein, the response RESPONSE is a kind of messages or packets which is transmitted after the memory system completely performs an operation in response to a command inputted from the host 102.

In an embodiment, there may be no particular limitation on a response for transmitting map information. For example, the memory system 110 may transmit the map information to the host 102 by using a response corresponding to a read command, a write command, or an erase command.

The memory system 110 and the host 102 may exchange a command or a response with each other in a specific format set according to a predetermined protocol. For example, a format of the response RESPONSE may include a basic header, a result or a state according to success or failure of the command inputted from the host 102, and additional information indicating an operational state of the memory system 110. The memory system 110 may add or insert map information into the format of the response RESPONSE to transmit the map information to the host 102.

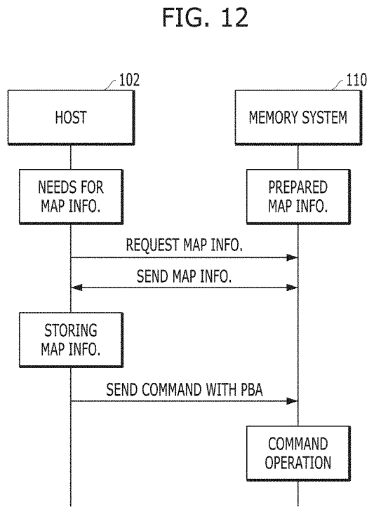

FIG. 12 illustrates a second operation between a host and a memory system according to an embodiment of the disclosed technology. FIG. 12 illustrates an operation where the host 102 first requests map information to the memory system 110 and then the memory system 110 transmits map information in response to a request of the host 102.

Referring to FIG. 12, needs for map information may occur at the host 102, or the memory system 110 may select or determine map information transmitted to the host 102 to prepare transfer of map information. For example, if the host 102 can allocate a space to store map information, or if the host 102 expects faster data input/output (I/O) of the memory system 110 in response to host's command, the host 102 can request the map information to the memory system 110. Needs may arise. In addition, needs for the map information may also be generated in the host 102 at user's request.

The host 102 may request map information to the memory system 110, and the memory system 110 may prepare map information in response to a request of the host 102 beforehand. In an embodiment, the host 102 may specifically request specific map information such as a specific range of map information to the memory system 110. In another embodiment, the host 102 may generally request map information from the memory system 110, and the memory system 110 may determine which map information is provided to the host 102.

After the memory system 110 may transfer prepared map information to the host 102, the host 102 may store transferred map information in an internal storage space, e.g., the host memory 106 described with reference to FIG. 4.

Using the stored map information, the host 102 may add the physical address PBA in a format of command COMMAND transmitted to the memory system 110 and transmit the format of command COMMAND including the physical address PBA. Then, the memory system 110 may use the physical address PBA inputted with the command COMMAND from the host 102 to perform an operation corresponding to the command COMMAND.

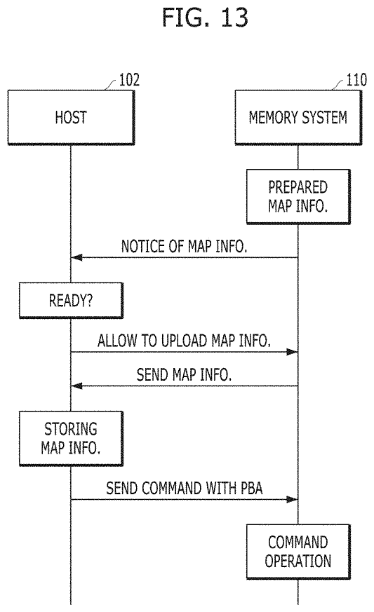

FIG. 13 illustrates a third operation between a host and a memory system based on an embodiment of the disclosed technology. In FIG. 13, the memory system 110 transmits an inquiry to the host 102 before transmitting map information. The host 102 determines whether to allow the transmission of the memory system 110 and sends the determination to the memory system 110. The memory system 110 transmits the map information based on the determination received from the host 102 and the host 102 receives the map information from the memory system 110.

Referring to FIG. 13, the memory system 110 may notify the host 102 of transmitting map information after determining which map information is transmitted. The host 102 can determine whether the host 102 can store the map information associated with the notification regarding transmission of the map information, which is delivered from the memory system 110. If the host 102 can receive and store the map information transmitted from the memory system 110, the host 102 can allow the memory system 100 to transfer the map information. In an embodiment, the memory system 110 may prepare map information to be transmitted, and then transmit the prepared map information to the host 102.

The host 102 may store the received map information in an internal storage space (e.g., the host memory 106 described with reference to FIG. 4). The host 102 may include a physical address PBA into a command to be transmitted to the memory system 110 after performing a mapping operation based on the stored map information.

The memory system 110 may check whether the physical address PBA is included in the command transmitted from the host 102, and apply the physical address PBA to perform an operation corresponding to the command.

Regarding the transmission of the map information, the host 102 can initiatively determine a transfer timing of map information between the host 102 and the memory system 110 described with reference to FIG. 12. But, the memory system 110 can initiatively determine a transfer timing of map information between the host 102 and the memory system 110 described with reference to FIG. 13 may be performed. According to embodiments, it can be different how the memory system 110 performs the transmission of the map information. According to an operational condition or environment, the memory system 102 and the host 110 may selectively use a method for transmitting map information described with reference to FIGS. 12 and 13.

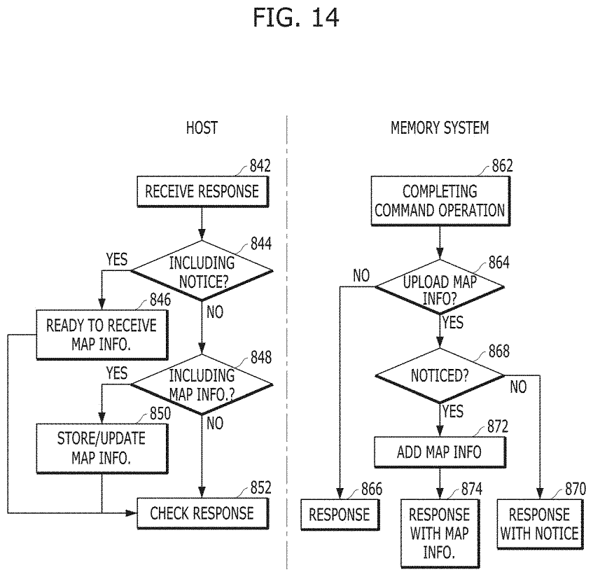

FIG. 14 illustrates a fourth operation between a host and a memory system according to an embodiment of the disclosed technology. FIG. 14 illustrates a case where the memory system attempts to transmit map information to the host while the host and the memory system are operatively engaged with each other.

Referring to FIG. 14, the memory system may determine whether an operation corresponding to a command transmitted from a host is completed (step 862). After the operation corresponding to the command is completed, the memory system may check whether there is map information to be transmitted to the host before transmitting a response corresponding to the command (step 864). If there is no map information to be transmitted to the host (NO in step 864), the memory system may transmit a response RESPONSE including information (e.g., success or failure) regarding whether the operation corresponding to the command sent from the host has completed (step 866).

When the memory system recognizes map information to be transmitted to the host (YES of step 864), the memory system may check whether a notice NOTICE for transmitting the map information has been made (step 868). The notification may be similar to that described with reference to FIG. 13. When the memory system wants to send the map information but the notification regarding the memory system sending the map information to the host has not been made in advance (NO of step 868), the memory system can add the notice NOTICE to the response RESPONSE. In addition, the memory system may transmit the response RESPONSE with the notice NOTICE to the host (step 870).

When the notice NOTICE for inquiring transmission of the map information has already been made (YES of step 868), the memory system may add the map information to the response (step 872). Thereafter, the memory system may transmit a response including the map information (step 874). According to an embodiment, the host can send a permission for transmitting the map information to the memory system before the memory system transmits the map information to the host.

The host may receive at least one of the response RESPONSE, the response including the notice (RESPONSE WITH NOTICE) and the response including the map information (RESPONSE WITH MAP INFO.), which are transmitted by the memory system (step 842).

The host may verify whether the received response includes the notice (step 844). If the received response includes the notice (YES of step 844), the host can prepare to receive and store map information that can be delivered later (step 846). Thereafter, the host may check the response corresponding to a command previously transmitted to the memory system (step 852). For example, the host can check the response to confirm whether an operation corresponding to a command previously sent is succeeded or failed in the memory system.

When the received response does not include the notice (NO of step 844), the host may determine whether the response includes map information (step 848). When the response does not include map information (NO of step 848), the host may check the response corresponding to the command previously transmitted to the memory system (step 852).

When the received response includes map information (YES at step 848), the host may store the map information included in the response within a storage space or update the map information already stored in the storage space (step 850). Then, the host may check the response corresponding to the command previously transmitted to the memory system (step 852).

Based on embodiments above described, the memory system may transmit the map information to the host. After processing the command transmitted by the host, the memory system may utilize a response associated with the command in order to transmit the map information. In addition, the memory system may transmit the map information to the host, and then generate and store a log or a history regarding the transmitted map information. Even if power is resumed after the power is not supplied to the host and the memory system, the memory system may transmit map information to the host using the log or the history above described. The host may transmit a command with logical and physical addresses to the memory system after performing a mapping operation or an address translation based on the transmitted map information. Through the command with the logical and physical addresses, data input/output (I/O) performance of the memory system can be improved or enhanced.

According to an embodiment of the disclosed technology, a data processing system, a method for operating the data processing system and a method of controlling an the operation in the data processing system can provide a memory system which is capable of performing a data input/output operation corresponding to a request delivered from a host (or a computing device) and an operation for sharing map information between the host (or the computing device) and the memory system. The data input/output operation can be performed independently from the operation for sharing map information between the host and the memory system. Accordingly, the operation for sharing the map information does not interrupt the data input/output operation of the memory system. Thus, it is possible not to deteriorate the performance of the memory system (e.g., input/output (I/O) throughput).

In an embodiment of the disclosed technology, a memory system can avoid the degradation of data I/O throughput of the memory system for determining which map information is transmitted from the memory system to an external device (e.g., a host or a computing device) and transmitting the determined map information to the external device. Thus, it is possible to enhance or improve operational efficiency of the memory system.

Further, according to an embodiment of the disclosed technology, a memory system can determine which map information is shared with a host (or a computing device) based on user's usage pattern of a data processing system including the memory system and the host (or the computing device), so that operational efficiency of the data processing system can be improved.

While the present teachings have been illustrated and described with respect to the specific embodiments, it will be apparent to those skilled in the art in light of the present disclosure that various changes and modifications may be made without departing from the spirit and scope of the disclosure.

What is claimed is:

1. A controller for controlling a memory device, the controller comprising:
first circuitry configured to perform a read operation in response to a read request, wherein the read operation includes an address translation, which is performed when an inputted physical address for the read operation is not valid, the address translation associating a logical address inputted along with the read request with a physical address by mapping the logical address to the associated physical address based on mapping information; and
second circuitry coupled to the first circuitry and configured to determine a usage frequency of the mapping information that indicates a number of times used for the address translation,
wherein the first circuitry and the second circuitry operate independently and separately from each other.

2. The controller according to claim 1, wherein the controller is configured to transmit at least some of the mapping information to the host based on the usage frequency of the mapping information.

3. The controller according to claim 2, wherein the controller is configured to check whether the at least some of the mapping information has been transmitted to the host and further check whether the transmitted mapping information has been updated in a case that the at least one of the mapping information has been transmitted to the host.

4. The controller according to claim 2, wherein the controller is configured to send an inquiry to the host to transmit the mapping information and transmit the mapping information based on a response from the host.

5. The controller according to claim 2, wherein each piece of the mapping information has a count information corresponding to the usage frequency and the controller is configured to determine which piece of the mapping information is to be transmitted to the host based on the count information.

6. The controller according to claim 5, wherein the controller is configured to initialize the count information of a certain mapping information after determining to transmit the certain mapping information to the host.

7. The controller according to claim 1, wherein the controller is configured to check whether the request is received with the corresponding physical address, and determine a validity of the corresponding physical address in a case that the corresponding physical address is received from the host.

8. The controller according to claim 1, wherein the controller is configured to perform the address translation when the request does not include the valid physical address and omit the address translation when the request includes the valid physical address.

9. A method for operating a memory system, comprising:
performing an operation in response to a request from a host by performing an address translation when the request includes an invalid physical address associated with the request, the address translation mapping a logical address included in the request to a corresponding physical address based on mapping information; and
determining a usage frequency of the mapping information that indicates a number of times used for the address translation,
wherein the performing of the operation and the determining of the usage frequency are executed using different resources of the memory system from each other.

10. The method according to claim 9, further comprising:
transmitting at least some of the mapping information to the host based on the usage frequency of the mapping information.

11. The method according to claim 10, further comprising:
checking whether the at least some of the mapping information has been transmitted to the host;
checking whether the transmitted mapping information has been updated in a case that the at least some of the mapping information has been transmitted to the host; and
excluding nonupdated one of the transmitted map data from the at least some of the map data.

12. The method according to claim 10, further comprising:
sending an inquiry to the host to transmit the at least some of the mapping information; and
transmitting the at least some of the mapping information based on a response from the host.

13. The method according to claim 10, wherein the determining of the usage frequency includes:
increasing count information of a piece of the mapping information whenever the piece of the mapping information is used for the address translation; and
determining to transmit, to the host, the piece of the mapping information that is greater than a threshold.

14. The method according to claim 13, further comprising:
initializing the count information of the piece of the mapping information after the determining to transmit the piece of the mapping information.

15. The method according to claim 9, further comprising:
checking whether the request has been received with the corresponding physical address; and
determining a validity of the corresponding physical address in a case that the corresponding physical address has been received from the host.

16. The method according to claim 15, further comprising:
performing the address translation when the request does not include the valid physical address and omitting the address translation when the request includes the valid physical address.

17. A data processing system, comprising:
a host configured to transmit an operation request with a logical address at which the operation is to be performed; and
a memory system configured to receive the operation request from the host and perform a corresponding operation at a location within the memory system, the location identified by a physical address associated with the logical address,
wherein the memory system includes:
first circuitry configured to perform an address translation depending on whether the operation request is inputted along with a valid physical address and the address translation mapping the logical address to the associated physical address based on mapping information; and
second circuitry coupled to the first circuitry and configured to determine a usage frequency of the mapping information used for the address translation,
wherein the first circuitry and the second circuitry operate independently and separately from each other.

18. The data processing system according to claim 17, wherein the memory system is configured to transmit at least some of the mapping information to the host based on the usage frequency.

19. The data processing system according to claim 17, wherein the memory system is configured to check whether the at least some of the mapping information has been transmitted to the host, and further check whether the transmitted mapping information has been updated in a case that the at least some of the mapping information has been transmitted to the host.

20. The data processing system according to claim 17, wherein the memory system is configured to check whether the operation request is received with the associated physical address, and determine a validity of the associated physical address in a case that the associated physical address has been received from the host.
